(19) United States
(12) Patent Application Publication
(10) Pub. No.: US 2018/0208484 A1
(43) Pub. Date: Jul. 26, 2018

(54) PROCESS FOR REMOVING HEAVY METALS FROM WATER

(71) Applicant: Arvind S. PATIL, Davidson, NC (US)

(72) Inventor: Arvind S. PATIL, Davidson, NC (US)

(73) Assignee: Surfatas, LLC, Huntersville, NC (US)

(21) Appl. No.: 15/412,442

(22) Filed: Jan. 23, 2017

(51) Int. Cl. C02F 1/28

(52) U.S. Cl. CPC C02F 1/283; C02F 2101/20

(57) ABSTRACT

The specific field of Invention relates to the surprising and wholly unexpected findings that so-called Catalytic Activated Carbons developed, either to remove chloramines, hydrogen sulfides and bromates or to purify and de-color the hydrocarbon liquids or to remove organic compounds from air, are also capable of removing dissolved heavy metals from contaminated drinking and waste water when given a range of contact times.

### 1) FIELD OF INVENTION

The specific field of Invention here relates to the surprising and wholly unexpected findings by the current Inventors that two types of so-called Catalytic Activated carbons, one originally developed to remove chloramines, hydrogen sulfides and bromates and the second type developed for purifying and decolorizing hydrocarbon fuels as well as removing organic chemicals from the air, are also capable of removing dissolved heavy metals in drinking and waste water, when given higher contact time.

The present invention relates to the field of removing various contaminants or impurities from water. Among the contaminants are dissolved organic compounds, including chloramines and Volatile Organic Compounds (VOC), and heavy metal ions. The contaminants are removed from the water by passing the water through a filter cartridge containing specific adsorbing media.

### BACKGROUND

Activated carbons designed to remove dissolved organic compounds, such as halomethanes and chloramines, as well as Volatile Organic Compounds (VOC) from drinking water, are produced from carbonaceous source materials, such as bamboo, nutshells, coconut shells, peat, wood, coir, lignite, bituminous and anthracite coal, and petroleum pitch by high temperature treatment in excess of 1300° F. Activated carbons, especially coconut shell based activated carbons, are known to be superior in removing the VOC compounds from drinking water, because of their optimum combination of micropores and mesopores. There are two additional classes of activated carbons made from bituminous coal, wood, and coconut shells that are called “Catalytic Activated Carbons”. The first class of these carbons are exposed to nitrogen containing compounds such as gaseous nitrogen, gaseous ammonia, nitriles, nitrosamines, cyanates, isocyanates, and oximes at temperatures in excess of 1300° F. The total amount of nitrogen containing compounds added to the carbon is between 1-8% but optimally between 2-5%. These catalytic carbons are mainly developed and used to remove chloramines, hydrogen sulfides and bromates.

Some of the relevant patents are:
1. U.S. Pat. No. 7,361,280 B2 assigned to MeadWestvaco
2. U.S. Pat. No. 5,444,031 assigned to Calgon Carbon
3. European Patent Application EP2 478,957,A1 assigned to Norit, Nederland.

The second class of catalytic activated carbons is activated with phosphoric acid under heat treatment under inert atmosphere such as nitrogen, carbon di oxide at temperature of 1000 to 2000° F. In addition transition metals such as copper, iron, chromium and manganese may be added in salt form before the heat treatment. Conversion of phosphoric acid to polymerized phosphate and reduced form of transition metal on the surface of carbon enhances its properties to purify and de-color hydrocarbon liquids and adsorb many organic chemicals both in liquid and air atmospheres through covalent bonding. The optimum polymerized phosphate contents are about 4 to 5% on the carbon, but can go as high as 10%. Reduced transition metal content is also in the 3 to 10% range.

Some of the relevant patents are:
1. US Patent Application No. US 2006/0223702 assigned to MeadWestvaco Corporation.
2. U.S. Pat. No. 4,148,753 assigned to Westvaco Corporation
3. U.S. Pat. No. 5,162,286 by James D. McDowell
4. PCT/US2006/010292 y Zhang & Miller assigned to MeadWestvaco Corporation

One of the major distinguishing features of these catalytic carbons is their ability to decompose hydrogen peroxide. The faster the decomposition of hydrogen peroxides, the better the catalytic properties in removing chloramines.

Heavy metal ions such as cadmium, mercury, lead, arsenic, and chromium are well known impurities in water. Some adsorbent materials are better at removing certain specific heavy metal ions, but not all of those set forth above. Therefore typical filters could have many different adsorbent components or polymeric ion exchange materials.

U.S. Pat. No. 8,887,923 (Stouffer et al) discloses a filter material that contains activated carbon for the removal of VOC's along with other ingredients such as Metsorb® adsorbent for the removal of lead and arsenic.

### SUMMARY OF THE INVENTION

Until the present invention, it was very challenging for a single media to remove chloramines, VOC's and heavy metal ions from water, especially drinking water, by passing the water through a single filter at high flow rates, typically greater than 5 gallons per minute. Unexpectedly the inventors discovered that activated catalytic carbon materials, based on the carbonaceous materials such as coconut shell and bituminous coal substrates developed for the removal of chloramines, sulfides and bromates as well as those developed for purifying and decolorizing hydrocarbon fluids, are also capable of removing at least 5 wt. % of the heavy metal ions such as lead and mercury and 3 to 1 wt. % of cadmium, copper, nickel and chromium, in addition to at least 0.2. % of the VOC's by passing the water through a filter containing such activated carbon material. Two examples of the Activated Catalytic Carbons are AquaSorb® CX-MCA (Jacobi Carbon Inc.) which is activated by nitrogenous compounds and Nuchar-AquaGuard 50 (Oxbow Activated Carbon LLC) which is activated by phosphoric acid process, or a mixture thereof. Other brands of catalytic carbons activated by one of above two methods are also expected to perform similarly based on the current surprising findings.

The following is the data developed by the Inventors to prove the Catalytic properties of these carbons:

Catalytic properties of some carbons were evaluated by measuring the decomposition of hydrogen peroxide. 0.5 g of carbon was contacted with 100 ml of 3.6% hydrogen peroxide solution for 10 minutes and remaining concentration was determined by Iodometric titration. The reduction in the concentration of peroxide is the indicator of the catalytic activity. The procedure was repeated to determine reproducibility.

| | % Reduction- | % Reduction- | |
|---|---|---|---|
| Name of Carbon | Apr. 1, 2014 | Apr. 21, 2014 | Remarks |
| Filtrex - EPC-5 | 62% | 58% | |
| Nuchar-AquaGuard 50 | 39% | 31% | |
| Jacobi-CX-MCA | 66% | 60% | |
| Blucher Beads | N/A | 16% | |
| Coconut Shell GAC | 14% | 11% | |

Filtrex—EPC 5 and Blucher Beads are some of the competitive catalytic carbons that are also surface treated with nitrogenous compounds, while coconut shell GAC is untreated conventionally activated carbon. For optimum performance, the combination of these two media with their similar adsorptive properties, but different bulk and true densities, allows attainment of optimum flow rate and contact time in a cartridge of a specific dimension.

In US, the Environmental Protection Agency (EPA) regulates the presence of Heavy metals in Drinking water. EPA sets so-called Maximum Contaminant Levels (MCL) for each metal depending on the toxicity of each individual metal to human and aquatic life. When the concentration of the particular dissolved metal exceeds the EPA set MCL for that metal, EPA mandates removal or elimination of that metal below the MCL.

There are also certain Independent agencies such as NSF International and Water Quality Association that certify the Drinking Water Treatment Devices to a consensus based standard that are at times even stricter that EPA. These standards specify the maximum concentration of a particular metal that should be used to challenge the Treatment device such as filter cartridge and the reduction in that concentration that filter or device must bring about in order to be certified as an efficacious device. In case of lead the NSF Standard 53 specifies that the device should be challenged with 150 parts per billion (ppb) lead and the resultant treated or filtered product must not be no more than 10 ppb, effecting a 93% reduction. Since 2007 this NSF Standard 53 for lead removal also requires the device under certification to be challenged by total of 150 ppb lead solution containing both soluble and at least 30% particulate lead, between 0.1 to 1.2 micron in size. The maximum allowable lead in the filtrate is still 10 ppb as before.

We have found that above mentioned catalytic carbons are capable of meeting these kinds of reductions, provided specific contact times are utilized.

If the product is not certified by NSF or WQA, it still must show substantial, preferably over 25% to 50% reduction in lead, to make a meaningful reduction claim.

### DESCRIPTION OF THE EMBODIMENTS

Filter media of the present invention are generally utilized at a substantial flow rate of more than 3 gallons per minute flow rate, for water at typical municipal water supply pressure of 60 psi, with preferred flow rates exceeding 5 gallons per minute for whole house or commercial filtration systems. Additionally, filters that operate under gravity, with flowrates between 0.13 to 0.3 gallons per minute are also an important part of this invention. The filter media includes catalytic activated carbons such as AquaSorb CX-MCA and/or Nuchar AquaGuard 50. The filter may also include other desirable materials such as one or more layers of non-woven fabrics and potential blending with conventional carbons. Suitable non-woven media include polyester, polyolefin such as polyethylene and polypropylene, nylon, or a combination of different polymers suitable for use in non-woven webs. These sheets of non-woven media retain the AquaSorb CX-MCA and Nuchar AquaGuard 50 within the filter housing and also act as a pre-filter to remove undesirable sediment which can clog the filter prematurely.

Removal of heavy metals in dissolved and colloidal particulate form, in combination with chloramines and VOC a by granular media has been a very difficult problem and none of the adsorptive granular media are currently available in the market that afford a low cost but effective solution, especially under gravity flow or at high flow rates, until the current invention. We have found that above two catalytic carbon media in granular form (AquaSorb CX-MCA and Nuchar AquaGuard 50) either singly or in various combinations can remove heavy metals such as lead, cadmium, copper, mercury, etc. in both soluble and colloidal particulate form. These two media have a synergistic effect and can be used advantageously in certain combinations to control the contact times and flow rates to achieve the optimum removal of heavy metals. Combined with their known capability to remove, chloramines and dissolved organic volatile compounds, they offer a combination of unique adsorptive properties.

Other catalytic carbon media, whether they are based on carbonaceous materials such as coconut or coal based material, whether activated at high temperature with nitrogenous compounds or with phosphoric acid will also perform in a similar way.

The uniqueness of this invention is finding that catalytic activated carbons based on carbonaceous materials such as coconut shell, coal, bamboo and such that can remove dissolved and particulate heavy metals. The use of conventionally activated carbons to remove VOC, is very well known in the art, but these carbons do not remove heavy metals beyond trace levels. We have found that catalytic activated carbons, specifically developed for removing chloramine, hydrogen sulfides and bromates or for purification and de-coloration of hydrocarbon liquids, uniquely remove heavy metals, only when utilized at the appropriate contact times. This invention thus allows important advantages of using the volume available in a filter cartridge most judiciously by using the multiple capabilities of the same media. Thus this invention makes it possible to remove chloramines, VOC, other organic chemical compounds and heavy metals using a single media, allowing judicious use of space in a filter cartridge

Heavy metal ions consists of those elements having an atomic number of 23-33, 40-52, 57-84, and 89-92. These heavy metal ions have a density greater than 5 g/ml. Specifically those heavy metal ions are: Vanadium, Chromium, Manganese, Iron, Cobalt, Nickel, Copper, Zinc, Gallium, Germanium, Arsenic, Zirconium, Niobium, Molybdenum, Technetium, Ruthenium, Rhodium, Palladium, Silver, Cadmium, Indium, Tin, Antimony, Tellurium, Lanthanum, Cerium, Praseodymium, Neodymium, Promethium, Samarium, Europium, Gadolinium, Terbium, Dysprosium, Holmium, Erbium, Thulium, Ytterbium, Lutetium, Hafnium, Tantalum, Wolfram, Rhenium, Osmium, Iridium, Platinum, Gold, Mercury, Thallium, Lead, Bismuth, Polonium, Actinium, Thorium, Protactinium and Uranium. Of these Chromium, Arsenic, Cadmium, Mercury and Lead are the most important. Also by heavy metal ions it is meant those that are positively charged species, cationic in nature. It excludes some of the heavy metals that form oxy-ionic species which are anionic in nature.

Contaminated water is typically defined as water with at least one ppm or more than the maximum amount of heavy metal ions allowed by EPA for drinking water and/or more than 1 ppm of any VOC more than the maximum amount of allowed by the EPA, such that it qualifies as contaminated water which is unsuitable to drink. When the contaminated water is treated, the AquaSorb CX-MCA and Nuchar AquaGuard 50 remove at least 90% of the heavy metal ions and at least 85% of the VOC present in the contaminated water. The heavy metal ions in the contaminated water include dissolved ions, particulate ions, or a mixture of both.

The process of removing heavy metals from contaminated water comprises a source of contaminated water with at least 1 ppm or some excess over the maximum EPA standard for heavy metal ions in drinking water; contacting said water with granular coconut shell based catalytic activated carbons, specified above, thereby removing at least 90% of said heavy metal ions. Preferably the process also removes at least 85% of the VOC. Filter media of the present invention are generally fabricated so they can be used in devices which can provide a substantial flow rate, of more than 3 gallons per minute, for water in pressurized systems and between 0.13 to 0.3 gallons per minute for gravity flow systems.

The ability of any filter media to remove the dissolved and particulate heavy metal contaminants in the water depends on the Empty Bed Contact Time (EBCT), which ensures that there is sufficient time for contaminants to come in intimate contact with the active sites of the media, where exchange reaction occurs. The EBCT is defined as:
EBCT=Volume of Bed containing Media÷Volume flow rate of Influent.
EBCT=Cubic Centimeters÷Cubic Centimeter per minute flow=Minutes

We have found that the optimum EBCT for the removal of dissolved and particulate heavy metals in drinking water for catalytic carbons such as AquaSorb CX-MCA and Nuchar AquaGuard 50 is between 0.64 to 1.77 minutes and higher. EBCT higher than 1.77 can create practical difficulties in designing the optimum bed dimensions. We have found that EBCT should preferably be between 1 to 1.77 minutes.

### EXAMPLES

### Example 1

Cation Exchange Capacity of AquaSorb—CX-MCA (by Jacobi Carbons, Inc.) and AquaGuard 50 (Oxbow Activated Carbon LLC.) both 20×50 mesh was determined by using a 500 ppm ammonia solution and equilibrating it for 24 hours. The saturation equilibrium capacity for both was determined by analyzing for remaining ammonia left in the solution by conventional colorimetric means and attributing the difference to the amount adsorbed or exchanged by the respective media. The Cation Exchange Capacity was thus determined for both and was found to be 1.25 meq./gram (milli-equivalents/gram) and 1.38 meq per gram, respectively. This proved that both AquaSorb and AquaGuard had a capacity to adsorb positively charged cation species by ion exchange. In addition some of the catalytic activated carbons also remove heavy metal by chelating or chemisorption and may exceed above number.

### Example 2

About 51 g of AquaSorb CX-MCA and 6 g of AquaGuard 50, both 20×50 mesh, were incorporated into pitcher cartridges that had a volume of 130 cc and were treated with 150 part per billion (ppb) lead solution containing 30% of the lead in a colloidal particulate form the remaining 70% being in the soluble form. Of the 30% particulate form about 35% was, above 0.1 micron and 65% between 0.1 and 1.2 micron in diameter. The NSF Standard requires the 150 ppb lead challenge solution to contain at least 20-40% of particulate lead above 0.1 micron and of that greater than 20% fine particulate between 0.1 and 1.2 micron. The pH of this solution was 8.5. About 44 wt. % of the colloidal particles were in the range of 0.1 to 1.2 micron in size. The influent containing 150 ppb Lead was flowed through the above pitcher cartridge at the rate of 100 cc/minute, giving the EBCT of 1.3 minutes. The lead concentration of 150 ppb in the influent was reduced by cartridges containing AquaSorb CX-MCA and AquaGuard 50 to 5 and 3 ppb, respectively, showing the capability of these two media to adsorb both soluble and colloidal lead to NSF 53 standard.

### Example 3

Three pitcher cartridges, having a volume of about 130 cc, all with 60 g of AquaSorb CX-MCA 12×40 mesh media were made. In order to control the flow rate and hence the contact time, the three cartridges were modified as follows: The first did not have any nonwoven polypropylene sheet at the bottom of the cartridge, whereas the second had one, and third had a two layer non-woven polypropylene sheets at the bottom. Similar adjustment of flow rate was also possible by combination of Jacobi CX-MCA and AquaGuard 50 as indicated in above examples. A solution of Cadmium at concentration of 30 ppb and at pH 8.5 was passed through the above three cartridges. There were 18% colloidal particles of cadmium, all or 100% of these particles were between the sizes of 0.1 micron to 1.2 micron. The results of the filtration trial with 30 ppb

Cadmium influent are given below:

| | Cartridge - A | Cartridge-B | Cartridge-C |
|---|---|---|---|
| Layers of Nonwoven | None | One | Two |
| EBCT | 0.39 | 0.64 | 0.77 |
| % Reduction in Cd | 83% | 95% | 99% |

NSF Standard 53 requires 30 ppb Cadmium solution to be reduced to 5 ppb with 83% reduction.

### Example 4

A pitcher cartridge having a volume of 130 cc, with one non-woven polypropylene sheet (similar to Cartridge B in Example 3 above was filled with 52 g of AquaSorb CX-MCA (12×40 mesh) and 6 g of AquaGuard 50 (20×50) mesh media. Another commercially available cartridge Claiming, removal of cadmium, and containing synthetic Ion Exchange Resin, which removes dissolved heavy metals such as cadmium, was also used to compare the results with the above sample. This commercial cartridge contains 19 g of conventional coconut shell GAC (8×30) mesh and 63 g of synthetic Cation Exchange Resin. The Synthetic Cation Exchange Resin is widely used to remove dissolved heavy metals. However they are not capable of removing colloidal particulate metals. In certain metals where there is no minimum requirement for the removal of colloidal particulates, their use is quite effective. Copper falls in this category. The above cartridge with AquaSorb CX-MCA and AquaGuard (Test Cartridge) and a commercial cartridge with synthetic ion exchange resin (Control) were used to test the reduction of a dissolved copper solution containing 3 parts per million (ppm) Copper. NSF Standard 53 requires the reduction of 57% in the effluent to 1.3 ppm. The results of filtration are as follows:

| | | Control- With |
|---|---|---|
| | Test-AquaSorb/ | Synthetic Ion |
| | AquaGuard | Exchange Resin |
| EBCT, Minutes | 0.64 | 0.27 |
| Cu in the Effluent in ppm | 0.5 ppm | 0.4 |
| % Reduction | 83% | 87% |

### Example—5

To prove that most of the activated carbons have capacity to remove (adsorb) VOC, an experiment was conducted using chloroform (Trichloromethane) as a contaminant. In NSF Standard 53, Chloroform is used as a surrogate indicator contaminant that mimics the adsorptive behavior of over 50 VOC compounds. In order to determine the equilibrium adsorption of chloroform on various activated carbons, in a 250 volume beaker, 0.2 g of each type of carbon (20×50 mesh) was equilibrated in 100 ml of chloroform solution in distilled water with the concentration of 2.38 mg/L of chloroform. The beakers were tightly sealed with plastic Saran Wrap® to prevent any loss of chloroform and water through transpiration. The beakers were mounted on a Rotary Shaker, and agitated for 48 hours. The supernatant from each beaker was then filtered through 1.2 micron filter and was analyzed by conventional analytical means for chloroform. Knowing the weight of carbon and the subtracting the remaining chloroform in the supernatant from the original concentration, equilibrium adsorption of chloroform on each of the carbons was determined. The results are as follows:

| ADSORBENT | CHLOROFORM ADSORBED (mg/g) |
|---|---|
| CX-MCA | 1.19 |
| AquaGuard -50 | 1.18 |
| Conventional GAC | 1.19 |

The above results clearly show that all activated carbons including CX-MCA and AquqGuard 50 have similar VOC adsorption capacity.

### Example—6

In order to show that CX-MCA and AquaGuard-50 are catalytic carbons that not only show the optimum kinetics in the decomposition of hydrogen peroxide, but are also capable of reducing the chloramines, an experiment was undertaken using a device about 9″ tall and 2½″ in diameter, that had a reservoir, about 590 ml for unfiltered water on the top 5″ of the device, interposed by a media cartridge, about 1½″ long containing about 25 g of media, with the chamber below this for the filtered water (about 1½″ in height with the volume of about 150 ml). The unfiltered water feeds by gravity, through the media contained in the cartridge, and accumulates in the lower reservoir almost instantaneously with a contact time between 0.5 to 1.5 minutes, depending on the hydraulic head.

Using above filter device, CX-MCA, AquaGuard-50 and conventional carbon were packed in the media cartridge successively and were challenged with a solution of 3 ppm of mono-chloramine. The NSF Standard 42 requires the concentration of 3 ppm mono-chloramine to be reduced after filtration to no higher than 0.5 ppm, effecting a 83% reduction. During this trial, three successive 150 ml filtrates were bulked and measured for mono-chloramine reduction. The results of this trial are as follows:

| | Reduction from 30 |
|---|---|
| Adsorbent | ppm Chloramine to |
| CX-MCA- (20 × 50 mesh) -25 g | 0.08 ppm |
| AquaGuard - 50 - (20 × 50) -15.3 g | 0.10 ppm |
| GAC control - (20 × 50) -25 g | 28.5 ppm |

### Example—7

The above experiment #5, was repeated in identical fashion except for the substitution of chloroform with 500 mg/L of lead in the original challenge solution. Lead served as an indicator species for cadmium, copper, mercury and many other divalent cationic heavy metal species. In a way identical to example 5, amount of lead adsorbed per gram was determined from the difference in concentration of lead between the original solution and the supernatant, knowing the weight of the activated carbon. The results of this experiment are

| | | CATION |
|---|---|---|
| | LEAD ADSORBED | EXCHANGE CAPACITY |
| ADSORBENT | (mg/g) | (meq/g) |
| CX-MCA | 130 | 1.25 |
| AquaGuard 50 | 143 | 1.38 |
| Conventional | 1 | Negligible - 0.01 |
| GAC | | |

Above results clearly show the uniqueness of CX-MCA and AquaGuard-50, in possessing the capability to remove heavy metals while still retaining the ability to remove VOC compounds.

Thus it is apparent that there has been provided in accordance with the invention, a novel process of removing heavy metal ions, dissolved organic compounds such as chloramines and VOC from contaminated water that fully satisfies the object, aims and advantages set forth above. Furthermore, the surprising findings that catalytic carbons are able to remove, heavy metals at a specific Empty Bed Contact Times, while retaining their ability to remove chloramines and VOC has been substantiated.

1) Process of using catalytic carbon to remove heavy metals from contaminated water by controlling the Empty Bed Contact Time between 0.1 to 2 minutes.

2) Process of claim 1 where catalytic activated carbon used is activated by nitrogenous compounds at temperatures in excess of 1000° F.

3) Process of claim 1 where catalytic activated carbon is activated by phosphoric acid with or without transition metal salts at temperatures in excess of 1000° F.

4) The process of claim 1 where the Empty Bed Contact time is 0.39 to 1.77 minutes and above.

5) The process of claim 1 where the Empty Bed Contact time is preferably between 1 and 1.77 minutes and above.

6) The process of claim 1, wherein said heavy metal ions means those elements having an atomic number of 23-33, 40-52, 57-84, and 89-92 and those that produce cationic species when dissolved in water.

7) The process of claim 1, wherein said heavy metal ions have a density of greater than 5 g/ml.

8) The process of claim 1 wherein said granular coconut shell based activated carbon is AquaSorb® CX-MCA or Nuchar-AquaGuard 50, or similar catalytic carbon products or a mixture thereof.

9) The process of claim 1 wherein said heavy metal ions are toxic to humans.

10) The process of claim 1 wherein the heavy metal ions include cadmium, mercury, arsenic, lead, chromium, or all other heavy metals that produce cationic species when dissolved in water or a mixture of 2 or more of these.

11) The process of claim 1, wherein the heavy metal ions in the water include dissolved ions, as well as particulate ions, or a mixture of both.

12) The process of claim 1 wherein said granular coconut shell based activated carbon is secured in a filter cartridge and the water is passed through the filter cartridge under controlled conditions for optimum contact.

13) The process of claim 8, wherein said water is passed through the filter media at a rate of ≤0.2, 0.75, 1, 1.5, 2, 3, 4, or even 5 gallons per minute.

14) The process of claim 8 wherein said filter media includes one or more thermoplastic woven sheets to retain the granular coconut shell based activated carbon and to control the flow.

15) The process of claim 1, where the catalytic carbons are part of consolidated carbon block brought about by sintering together of powdered catalytic carbons and a polymeric binder.
